(19) United States
(12) Patent Application Publication
(10) Pub. No.: US 2003/0085523 A1
(43) Pub. Date: May 8, 2003

(54) Novel paintball velocimeter and closed-loop regulation

(76) Inventors: Glenn F. Spaulding, Houston, TX (US); Anthony Spaulding, Houston, TX (US)

Correspondence Address: Glenn Spaulding, 16811 Soaring Forest, Houston, TX, 77059, US

(21) Appl. No.: 10/205,431

(22) Filed: Jul. 25, 2002

Related U.S. Application Data
(60) Provisional application No. 60/309,320, filed on Aug. 2, 2001.

(51) Int. Cl. F41J 5/02; G01N 21/86

(52) U.S. Cl. 273/317; 273/348; 250/222.2; 250/221; 250/559.32

(57) ABSTRACT

A novel simple low cost paintball velocimeter is described. It is small, utilizing a light source and photodetection methods that can serve as a stand-alone velocimeter or integrated into the firing mechanism for greater control and accuracy. Additional features include an ability to collect, store and process data for graphical display and analysis.

This application is a Continuation-In-Part of:

U.S. Provisional Patent Application Serial No. 60/309,320, filed on Aug. 2, 2001

The above identified application is hereby expressly incorporated herein by reference.

### BACKGROUND

Paintballing is a newly emerging game that is showing increasing popularity. A paintball is comprised of a spherical gelatin shell filled with a biodegradable paint. Paintballs are spherical having a general diameter of 0.68 inches. A paintball gun utilizes compressed air to propel the paint ball at a target. In practice, paintball velocities are generally maintained between 280 and 300 fps. Velocity adjustments are often made by a screw adjustment. The screw adjustment increases or decreases the volume of gas or the pressure at which the gases expelled. Ultrasound and microwave are the current means by which the paintball velocity is measured as it leaves the barrel. Both approaches to velocimetry require a substantial amount of acquisition time, are costly to implement, require an open space for the paintball to transition, and a bulky detector for implementation. The novel optical paintball velocimetry is herein disclosed that acquires velocity, is low-cost, is small in size, enables paintball quality control, and is fast for closed loop feedback control of an electronic gas regulator.

### THE FIELD OF INVENTION

The field of this invention is the optical measurement of paintball movement. Movement can be translated to velocity or acceleration, and non-annular velocity e.g. wobble, bend, or off axis movement. Paintball velocity measurements can be used in a closed loop control approach to the regulation of gas release, bolt movement, paintball feed, and ball counting. In regulating gas released, ball movement, and/or paintball feed, the paintball gun becomes more accurate and reliable. Furthermore, the data can be acquired and stored for display and analysis at a latter time.

### DESCRIPTION

FIG. 1 is an illustration of the external attachment of the velocimetry to the paintball gun barrel.

FIG. 2 is an illustration of light piping into the bolt of a paintball gun for velocimetry measurements.

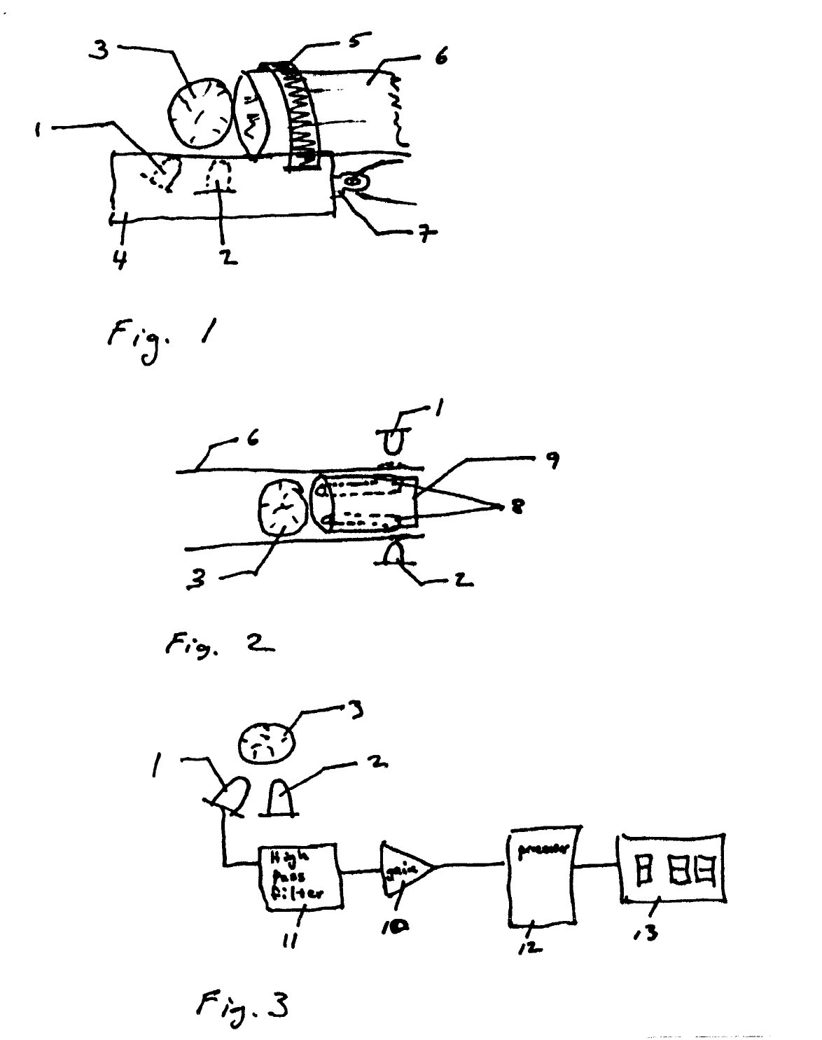

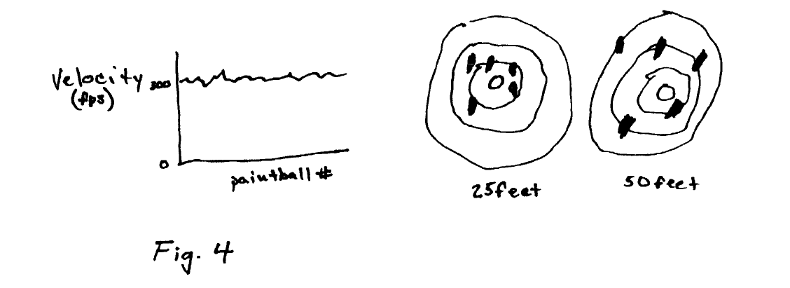

FIG. 3 is a schematized diagram of the electronics for light measurement.

FIG. 4 is an illustration of the printed output for data analysis.

In general, the velocimetry enclosure 4 is disposed to the paintball gun barrel 6 by means of Velcro, elastic or other means 5. Said enclosure houses a light source 2 and photodetector 1. Said light source and photodetector gather scattered light from the paintball 3 as it passes through the light source's light path. The duration of collecting light scattered from the paintball is proportional to the paintball's velocity. When not in use, a means of attachment 7 may be included to secure the enclosure to a belt loop or hang the enclosure or around the users neck. Alternatively, light may be piped through the side of the paintball gun 6 into a light pipe 8 contained within the bolt 9. Light exiting the light pipe would be reflected off the paintball back into a second light pipe. The second light pipe would bring reflected light back to a photodetector. When the paintball is expelled, light reflected off the paintball would diminish in proportion to the velocity (or acceleration) of the paintball. To determine paintball velocity the paintball must be in motion. A light source, for example an LED 1 or laser diode, is positioned in such a way that the light path intersects with the moving paintball. Light is reflected off the paintball 3 during the time the paintball is in the light path. That reflected light is collected by a photodetector 2. The duration that the light impinges upon the photodetector is proportional to the paintball velocity. The electronic signal obtained from the photodetector may be amplified 11 and may be filtered 10 to remove ambient light. Signal duration is determined by can embedded microprocessor 12 or programmable array and translated for display 13. In addition to displaying the velocity or acceleration, the electronic signal can be used in a closed loop control approach to paintball velocity control, paintball counting, paintball feed regulation, bolt timing and regulation, and in paintball quality control. For example in using a bolt with a light pipe, the photodetector signal obtained from acceleration can be fed back to the gas release mechanism thereby precisely controlling the gas release mechanism. Moreover, if a paintball is not detected the bolt can be repositioned and or a paintball fed into the chamber for the next shot. The combination of knowing when and at what rate the paintball left the chamber will enhance the feed rate, reduce the ball damage, and enhance shot to shot reproducibility.

In an alternative embodiment, a light source is positioned such that the light path intersects the paintball path, and is directed into the photodetector. When a paintball crosses the light source's path, light entering the photodetector is obstructed. The duration of interruption is proportional to the velocity of the paintball. A mechanical assembly holds said photodetector, light source and paintball barrel in alignment. To reduce the amount of ambient light impinging upon the photodetector, the mounting position of the photodetector is offset from the paintball barrel and collects light through a cylindrical hole in the mounting assembly. Said cylindrical hole has its annular axis aligned with the annular axis of the light source. The length and diameter of said cylindrical serves to block ambient light from directly impinging upon said photodetector. Hence, said cylindrical opening in front of the photodetector becomes a spatial filter that reduces ambient light by requiring ambient light rays to reflect off at least one wall of said cylindrical opening before impinging upon said photodetector. Further improvement in signal to noise ratios are obtained by utilizing an infrared light source and an infrared photodetector. Said infrared light sources can be commercially available LEDs or laser diodes. Said infrared photodetector can be commercially available photodetector encased in visible light absorbing material or having an infrared filter mounted in front of the photodetector. Said photodetector can incorporate additional circuit integration for improved performance and reduced cost and complexity, for example: a photodetector with integrated amplifier, a photodetector with integrated amplifier and logic for threshold evaluation, a photodetector with temperature compensation, a photodetector with voltage or current regulation, or some combination of the above.

There are several advantages in the novel approach of single photodetector/light source with spatial filtering design—for paintball velocity determination. First, there is reduced cost and complexity having only a single light source and photodetector. Second, the size of the enclosure can be reduced to less than 1×1×0.5 cm. Third, response time is very fast and can be used in feedback control, as previously described. Fourth, software and embedded controller processing time is reduced by having a single very fast (microseconds) pulse for pulse width measurement. Fifth, the cylindrical opening—spatial filter technique, further reduces size and cost of the enclosure and mechanical alignment assembly. Sixth, power consumption is minimized.

In broadening the design embodiment, an embedded controller is included as an additional feature. Said embedded controller can process and store information, then transmit that information to other computers. In one embodiment, said embedded controller stores the velocity of each paintball. Velocity information is constantly updated and evaluated to obtain such parameters as: minimum paintball velocity, maximum paintball velocity, average paintball velocity, running average velocity (for example last 5 shots), standard deviation of velocity, off nominal velocity (where for example an indicator LED alerts the operator—which may indicate a broken paintball situation), number of paint balls shot, time between shots, paintball color type, paintball spherical uniformity, and/or paintball wobble. Said collected parameters or raw data can be transmitted to other computers for processing and display. Communication can be via infrared LED link or radio frequency link. Once downloaded to another computer, novel software can evaluate the data and display the results. Said evaluation can include: minimum paintball velocity, maximum paintball velocity, average paintball velocity, running average velocity (for example last 5 shots), standard deviation of velocity, off nominal velocity (where for example an indicator LED alerts the operator—which may be a broken paintball), number of paint balls shot, time between shots, paintball color type, paintball spherical uniformity, paintball wobble, plots of parameters, indicators on said plots of problem, data base of paintball type used, and/or compilations of parameters for optimizing paintball accuracy and operation.

To aid in evaluation the paintball data, graphical and alphanumeric data can be uniquely arranged to identify various changes that affect paintball accuracy, e.g. paintball quality, barrel quality, gas regulation, gas delivery. Using this uniquely arranged data various parameters can be changed to identify sources for improved paintball accuracy. For example, velocity data can be plotted as velocity verses paintball order verses paintball type to identify which paintball has a more consistent velocity and therefore accuracy. Statistical analysis can be added to refine the identification of improvements. To help people that may want a less mathematical visual analysis, a novel illustration of impact on target is herein disclosed. A ‘bulls eye’ target is displayed. The impact on the target at various ranges, e.g. 25, 50, and 75 feet, is displayed as a paintball splatter. The vertical location of the impact is calculated based on the target distance and paintball velocity. Low velocity paintballs having a lower impact with respect to the ‘bulls eye’, higher velocity paintballs having a higher impact location. The horizontal impact location can be set to zero (bull's eye) or randomized to the paintball but matched to the distribution of the plotted data. By fitting the horizontal distribution to match the vertical distribution distance, the plotted impact location appears more realistic and improves understanding.

Means for disposing the paintball velocimeter enclosure to a paintball barrel include: a cylindrical opening that perpendicularly intersects said light path for said light source. The end of said cylindrical opening that is furthest away from said paintball barrel encompasses said light source and photodetector, having a diameter of not less than 1.73 centimeters. The end of said cylindrical opening that is disposed to said paintball barrel may be tapered and/or include one or more o-rings to accommodate paintball barrels of differing diameters, or may have a mechanical ‘U’ shaped assembly. The purpose of said taper and/or o-rings or mechanical assembly is to align said barrel to the annular axis of the cylindrical passage and to provide simple mounting. It should be appreciated that said mounting design is low cost and allows for simple and quick attachment and removal.

In an alternative embodiment, a laser diode is used as both the light source and photodetector. Laser diodes have built in photodetectors for laser light monitoring and control. Said built in photodetector can be used to collect both direct laser light for monitoring output and light reflected off a paintball or light reflected off a reflector opposite the laser diode. In the case of light reflected off said paintball, the photodetector would detect an increase in light, the duration of increase being proportional to said paintball velocity. In the case of light reflected of an opposing wall and aligned perpendicular to said paintball path, the light path would be interrupted said interruption being proportional to said paintball velocity.

In an embodiment to reduce ambient light, said laser diode is modulated and demodulated to subtract ambient light. Modulation and demodulation can be used alone or in combination with spatial filter and/or wavelength filtering.

I claim:

1. An optical method for determining the velocity of a paintball comprising:
a light source with light path directed at a moving paintball,
a photodetector means for collecting light reflected from said moving paintball,
said photodetector means having a cylindrical opening as a spatial filter in said light path,
said reflected light from said moving paintball collected by said photodetector, and
said reflected light collection duration is proportional to said paintball velocity.

2. Said photodetector of claim 1 being sensitive to infrared light.

3. Said light source of claim 1 emitting infrared light.

4. The light path of claim 1 following a light pipe embedded in a bolt and reflecting off a paintball.

5. The frequency of occurrence of the signal from claimed 1 used to count paint balls.

6. The photodetector signal of claim 1 used to close loop feedback control the duration of the gas released to propel said paintball.

7. Said photodetector signal of claim 1 used to close loop feedback control the bolt movement timing and paintball feed.

8. An apparatus for determining the velocity of a paintball comprising:
a light source with light path directed at a moving paintball,
a photodetector means for collecting light reflected from said moving paintball,
said photodetector means having a cylindrical opening as a spatial filter in said light path,
said reflected light from said moving paintball collected by said photodetector, and
a means for determining reflected light collection duration and computing said paintball velocity.

9. Said photodetector of claim 2 being sensitive to infrared light.

10. Said light source of claim 2 emitting infrared light.

11. The light path of claim 2 following a light pipe embedded in a bolt and reflecting off a paintball.

12. The frequency of occurrence of the signal from claimed 2 used to count paint balls.

13. The photodetector signal of claim 2 used to close loop feedback control the duration of the gas released to propel said paintball.

14. Said photodetector signal of claim 2 used to close loop feedback control the bolt movement timing and paintball feed.

15. Said photodetector signal of claim 2 used to close loop feedback control the bolt movement timing and paintball feed.

16. A method for displaying paintball velocity data comprising:
an xy plot of the paintball velocity for each paintball fired, and
a bull's eye target with graphical indications showing where said paintball would impact based on paintball velocity and target distance.
